(19) United States
(12) Patent Application Publication
(10) Pub. No.: US 2024/0037445 A1
(43) Pub. Date: Feb. 1, 2024

(54) PESSIMISTIC OFFLINE REINFORCEMENT LEARNING SYSTEM AND METHOD

(71) Applicants: Denso International America, Inc., Southfield, MI (US); DENSO CORPORATION, Aichi (JP)

(72) Inventors: Minglei Huang, Novi, MI (US); Jinning Li, Berkeley, CA (US); Chen Tang, Berkeley, CA (US); Masayoshi Tomizuka, Berkeley, CA (US); Wei Zhan, Berkeley, CA (US)

(73) Assignees: Denso International America, Inc., Southfield, MI (US); The Regents of the University of California, Oakland, CA (US); DENSO CORPORATION, Aichi (JP)

(21) Appl. No.: 17/969,129

(22) Filed: Oct. 19, 2022

Related U.S. Application Data
(60) Provisional application No. 63/393,600, filed on Jul. 29, 2022.

(51) Int. Cl. G06N 20/00; G06N 7/00

(52) U.S. Cl. CPC G06N 20/00; G06N 7/005

(57) ABSTRACT

Systems and methods for pessimistic offline reinforcement learning are described herein. In one example, a method for performing offline reinforcement learning determines when sampled states are out of distribution, assigns high probability weights to the sampled states that are out of distribution, generates a fitted Q-function by solving an optimization problem with a minimization term and a maximization term, estimates a Q-value using the fitted Q-function by estimating the overall expected reward assuming the agent is in the present state and performs a present action, and updates the policy according to an existing reinforcement learning algorithm. The minimization term penalizes an overall expected reward when a present state is out of distribution. The maximization term cancels the minimization term when the present state is an in-distribution state.

### CROSS-REFERENCE TO RELATED APPLICATION

This application claims priority to U.S. Provisional Patent Application Ser. No. 63/393,600 filed on Jul. 29, 2022, the entire contents of which are hereby incorporated by reference in its entirety.

### TECHNICAL FIELD

The subject matter described herein relates, in general, to systems and methods for performing offline reinforcement learning.

### BACKGROUND

The background description provided is to present the context of the disclosure generally. Work of the inventor, to the extent it may be described in this background section, and aspects of the description that may not otherwise qualify as prior art at the time of filing, are neither expressly nor impliedly admitted as prior art against the present technology.

Reinforcement learning (RL) is an area of machine learning that focuses on how intelligent agents ought to perform actions in an environment to maximize the cumulative reward. In RL, a method of rewarding desired behaviors and punishing negative behaviors assigns positive values to the desired actions to encourage the agent and negative values to desired behaviors to discourage the agent. This essentially trains the agent to seek a long-term and maximum overall reward to achieve an optimal solution.

RL has some advantages over other types of learning, such as supervised learning, in that RL does not require label training data. However, typical training schemes of RL algorithms rely on active interaction with the environments. It limits their applications in domains where active data collection is expensive or dangerous (e.g., autonomous driving). Recently, offline reinforcement learning (offline RL) has emerged as a promising candidate to overcome this barrier. Unlike traditional RL methods, offline-RL learns the policy from a static offline dataset collected without iterative interaction with the environment.

However, offline RL methods suffer from several issues, such as distributional shift. Unlike online RL algorithms, the state and action distributions are different during training and testing. As a result, RL agents may fail dramatically after being deployed online. For example, in safety-critical applications such as autonomous driving, overconfident and catastrophic extrapolations may occur in out-of-distribution (OOD) scenes.

### SUMMARY

This section generally summarizes the disclosure and is not a comprehensive explanation of its full scope or all its features.

In one embodiment, a method performs offline reinforcement learning to iteratively update an agent that possesses a policy and a Q-function based on a dataset ( [symbol] ), the dataset ( [symbol] ) having in-distribution states. The method includes the steps of sampling states over a whole state space, determining when sampled states are out of distribution, assigning high probability weights to the sampled states that are out of distribution, updating the Q-function to generate a fitted Q-function by solving an optimization problem with a minimization term and a maximization term, estimating a Q-value using the fitted Q-function by estimating the overall expected reward assuming the agent is in the present state and performs a present action; and updating the policy according to an existing reinforcement learning algorithm. The minimization term penalizes an overall expected reward when a present state is out of distribution. The maximization term cancels the minimization term when the present state is an in-distribution state.

In another embodiment, a system for performing offline reinforcement learning to iteratively update an agent that possesses a policy and a Q-function based on a dataset ( [symbol] ), the dataset ( [symbol] ) having in-distribution state includes a processor and a memory. The memory is in communication with the processor and includes an offline learning module.

The offline learning module includes instructions that, when executed by the processor, cause the processor to determine when sampled states are out of distribution, assigns high probability weights to the sampled states that are out of distribution, generate a fitted Q-function by solving an optimization problem with a minimization term and a maximization term, estimate a Q-value using the fitted Q-function by estimating the overall expected reward assuming the agent is in the present state and performs a present action, and update the policy according to an existing reinforcement learning algorithm. Like before, the minimization term penalizes an overall expected reward when a present state is out of distribution, while the maximization term cancels the minimization term when the present state is an in-distribution state.

In yet another embodiment, a non-transitory computer-readable medium stores instructions for performing offline reinforcement learning to iteratively update an agent that possesses a policy and a Q-function based on a dataset ( [symbol] ), the dataset ( [symbol] ) having in-distribution states. The instructions, when executed by the processor, cause the processor to determine when sampled states are out of distribution, assigns high probability weights to the sampled states that are out of distribution, generate a fitted Q-function by solving an optimization problem with a minimization term and a maximization term, estimate a Q-value using the fitted Q-function by estimating the overall expected reward assuming the agent is in the present state and performs a present action, and update the policy according to an existing reinforcement learning algorithm. Again, the minimization term penalizes an overall expected reward when a present state is out of distribution, while the maximization term cancels the minimization term when the present state is an in-distribution state.

Further areas of applicability and various methods of enhancing the disclosed technology will become apparent from the description provided. The description and specific examples in this summary are intended for illustration only and are not intended to limit the scope of the present disclosure.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates a prior art example of traditional reinforcement learning.

FIG. 2 illustrates an example of offline reinforcement learning.

FIG. 3 illustrates a system for performing pessimistic offline reinforcement learning.

FIG. 4 illustrates a method for performing pessimistic offline reinforcement learning.

### DETAILED DESCRIPTION

Described are systems and methods for performing pessimistic offline RL. Offline RL requires learning skills from previously collected data sets without any active environment interaction. As such, offline RL allows for utilizing previously collected datasets from various sources, including human demonstrations, prior experiments, domain-specific solutions, and even data from different but related problems, to build complex decision-making engines. However, offline RL requires handling distributional shifts, making it difficult to learn from a fixed data set effectively.

The systems and methods described herein for performing pessimistic offline RL limit the policy from visiting unseen states and actions. Broadly, the pessimistic offline RL systems and methods limit the magnitude of the value function at unseen states so that the agent can avoid or recover from unseen states by detecting out of distribution (OOD) states and shaping the value function at those OOD states.

To provide further background regarding RL, reference is made to FIG. 1, which illustrates a prior art traditional online RL learning process flow 10. Here, illustrated as a policy 12 and an environment 14. The policy 12 generally defines an agent's way of behaving at a given time. The environment 14 is the environment in which the agent operates within. When the agent performs a particular action 16 based on the policy 12, a change of state 18 occurs, and reward 20 is generated. Based on this reward 20, the policy 12 is updated to generate a new policy 22, which the agent in subsequent episodes then utilizes to determine what types of actions should be performed. Over time, as the agent interacts with the environment, the agent gathers data for learning each skill and task and updates its policy accordingly.

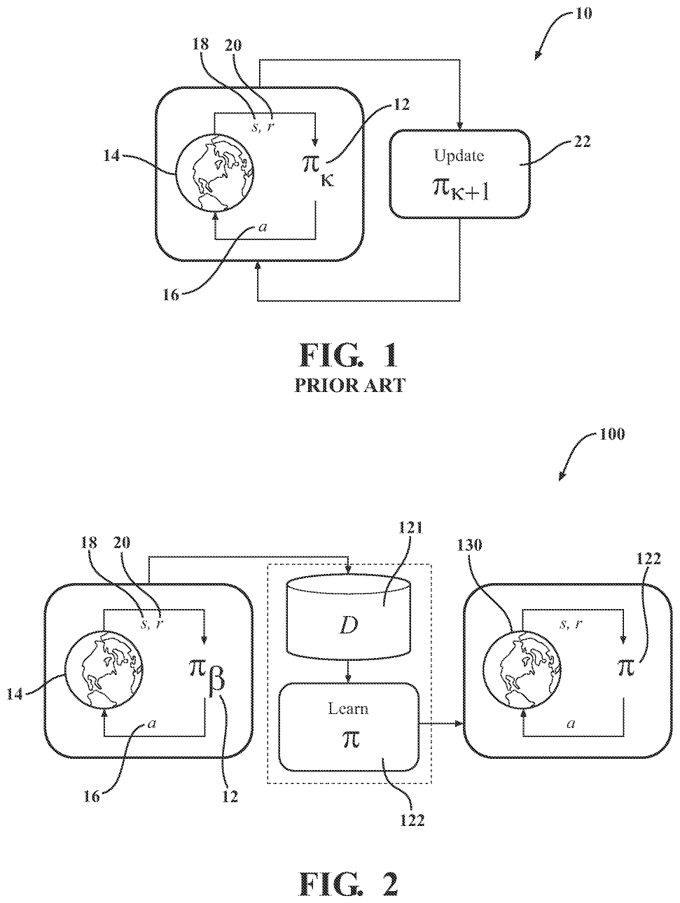

Referring to FIG. 2, one example of a process flow 100 for offline RL is illustrated. Offline RL is similar to online RL but differs in at least one aspect. Moreover, instead of having the agent interact with the environment 14, the policy 12 is trained offline using data from a data set 121 to generate an updated policy 122. Eventually, after it is fully trained, the updated policy 122 may then be deployed in the real world 130. Real-world applications for utilizing the updated policy 122 can include any one of several different uses. For example, the updated policy 122 can be utilized in robotic applications, such as robotic control and/or autonomous vehicles.

In particular, Q-Learning may be used for offline RL. Q-Learning uses a table to store all Q-Values of all possible state-action pairs possible. Q-Values may also be estimated by a continuous function when the state space is continuous. In one example, the table can be updated dynamic programming, such as the Bellman update, while action selection is usually made with an ε-greedy policy. Q-Values measure the overall expected reward assuming the agent is in state s and performs action a, and then continues playing until the end of the episode following some policy π.

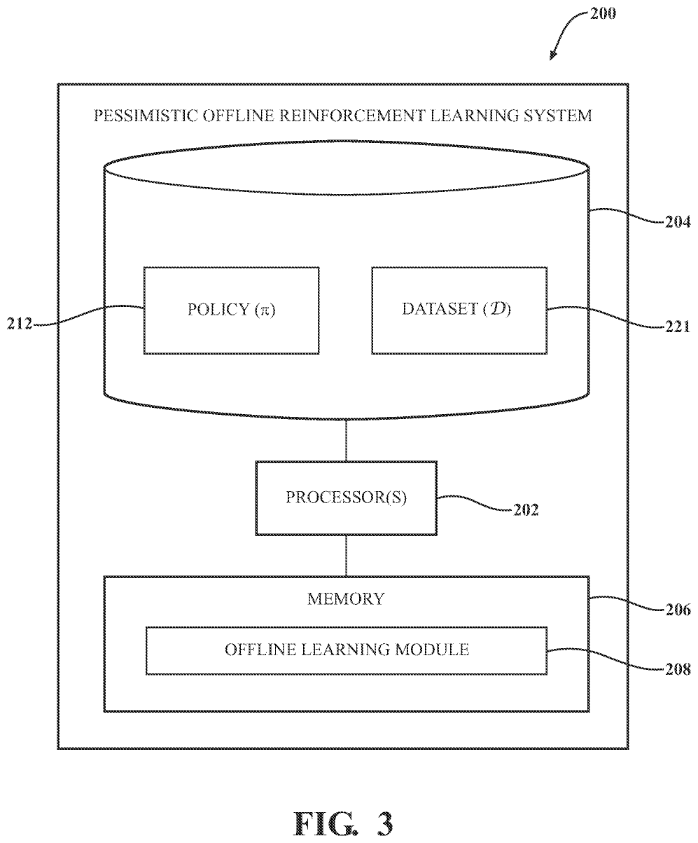

Referring to FIG. 3, one example of a pessimistic offline RL system 200 is shown. In this example, the pessimistic offline RL system 200 includes one or more processor(s) 202, one or more data store(s) 204 that is in communication with the processor(s) 102, and a memory 206 that is also in communication with the processor(s) 202. Accordingly, the processor(s) 202 may be a part of the pessimistic offline RL system 200 or the pessimistic offline RL system 200 may access the processor(s) 202 through a data bus or another communication path. In one or more embodiments, the processor(s) 202 may be an application-specific integrated circuit that is configured to implement functions associated with an offline learning module 208. In general, the processor(s) 202 are an electronic processor such as a microprocessor that is capable of performing various functions as described herein.

As stated before, the pessimistic offline RL system 200 may include a memory 206 that stores the offline learning module 208. The memory 206 may be a random-access memory (RAM), read-only memory (ROM), a hard disk drive, a flash memory, or other suitable memory for storing the offline learning module 208. The offline learning module 208 is, for example, computer-readable instructions that, when executed by the processor(s) 202, cause the processor(s) 202 to perform the various functions disclosed herein.

With regards to the data store(s) 204, the data store(s) 204 are, in one embodiment, an electronic data structure such as a database that is stored in the memory 206 or another memory and that is configured with routines that can be executed by the processor(s) 202 for analyzing stored data, providing stored data, organizing stored data, and so on. Thus, in one embodiment, the data store(s) 112 stores data used by the offline learning module 208 in executing various functions.

In one embodiment, the data store(s) 112 includes a policy (π) 212 and a dataset ( [symbol] ) 221. The policy (π) 212 is, in one example, a mapping from some state s to the probabilities of selecting each possible action a given that state. As such, policy (π) 212 generally dictates the action to be taken by an agent at a particular state. The dataset ( [symbol] ) 221 generally contains transitions that have been observed by having the agent that utilizes the policy (π) 212 perform an action that moves it from one state to another. As such, the dataset ( [symbol] ) contains the transitions between different states. States that are part of the dataset ( [symbol] ) are considered seen or in-distribution states, while states that are not part of the dataset ( [symbol] ) are considered unseen or OOD states. As mentioned previously, offline RL methods suffer from several issues, such as distributional shift. Moreover, the state and action distributions are different during training and testing. As a result, RL agents may fail dramatically after being deployed online.

Concerning the offline learning module 208, the offline learning module 208 includes instructions that, when executed by the processor(s) 202, cause the processor(s) 202 to perform pessimistic offline RL as will be described in greater detail in this description, the offline learning module 208 causes the processor(s) 202 limit the policy (π) 212 from visiting unseen states and actions. This is accomplished by limiting the magnitude of the value function at unseen states so that the agent can avoid or recover from unseen states by detecting out of distribution (OOD) states and shaping the value function at those OOD states.

Here, the offline learning module 208 includes instructions that, when executed by the processor(s) 202, cause the processor(s) 202 to sample states over a whole state space. The sampling of states over a whole state space can include states that are OOD and in-distribution states. As mentioned previously, in-distribution states are states that are within the dataset ( [symbol] ) 221, while OOD states are states that are not within the dataset ( [symbol] ) 221.

To determine if the state is in-distribution or OOD, the offline learning module 208 causes the processor(s) 202 to determine when sampled states are OOD. Moreover, an appropriate distribution d^{ϕ}(s), which requires a tool for OOD state detection should be utilized. In one example, the offline learning module 208 cause the processor(s) 202 to train a bag of dynamics models (\hat{P}₁, \hat{P}₂, . . . \hat{P}ₙ) according to transitions within a dataset ( [symbol] ) 221 to output an uncertainty estimation model that indicates when the present state is the OOD state.

In one example, the processor(s) 202 trains the bag of dynamics models (\hat{P}₁, \hat{P}₂, . . . , \hat{P}ₙ) where each model is \hat{P}ᵢ(·|s, a)= [symbol] (s+\hat{ƒ}_{ϕ}_{ᵢ}(s, a), \hat{Σ}_{ϕ}_{ᵢ}). The function \hat{ƒ}_{ϕ}_{ᵢ} outputs the mean difference between the next state and the current state, and Σ_{ϕ}_{ᵢ} models the standard deviation. OOD states are detected by estimating the uncertainty of bootstrap models at a given state s∈ [symbol] . The processor(s) 202 may define u_{π}(s)=

$${u}_{π} ( s ) = {a \sim π ( a \vert s )}_{} [ \frac{1}{n} {\sum }_{i = 1}^{n} {( {\hat{f}}_{{ϕ}_{i}} ( s , a ) - {\overline{f}}_{ϕ} ( s , a ) )}^{2} ] ,$$

where

$${\overline{f}}_{ϕ} ( s , a ) = \frac{1}{n} {\sum }_{i = 1}^{n} {\hat{f}}_{{ϕ}_{i}}$$

(s, a) is the mean of outputs of all the function 4, and the actions are drawn from a policy distribution π. A high u_{π}(s) value indicates the state is more likely to be an unseen state. Given a set of sampled states {S₁, S₂, . . . , Sₙ}, the processor(s) 202 may output a) discrete distribution over it using u_{π}(s):

$$ζ ( {s}_{i} ) = \frac{u ( {s}_{i} )}{{\sum }_{j} u ( {s}_{j} )} ,$$

i=1, 2, . . . , n, which assigns high probabilities to OOD states. As will be explained later, this can be utilized to construct the distribution d^{ϕ}(s).

Next, the offline learning module 208 causes the processor(s) 202 to update the Q-function to generate a fitted Q-function by solving an optimization problem with a minimization term and a maximization term. The minimization term penalizes an overall expected reward when a present state is OOD. The maximization term cancels the minimization term when the present state is an in-distribution state. The fitted Q-function may be a conservative Q-function that lower-bounds an actual Q-function corresponding to an underlying Markov Decision Process in the dataset ( [symbol] ) 221.

Moreover, assuming the dataset ( [symbol] ) 221 is collected with a behavior policy π_{β}(a|s) (policy (π) 212), and the states s are distributed according to a distribution d^{π}^{_{β}}(s) in the dataset ( [symbol] ) 221, the offline learning module 208 causes the processor(s) 202 to solve the problem caused by state distributional shift by using a regularization term scaled by a trade-off factor ε:

$${min}_{Q} ε ( {𝔼}_{s ∼ {d}^{ϕ} ( s ) , a ∼ {\hat{π}}^{k} ( a \vert s )} [ Q ( s , a ) ] - {𝔼}_{s ∼ {d}^{π} β ( s ) , a ∼ {\hat{π}}^{k} ( a \vert s )} [ Q ( s , a ) ] ) + ε ( Q , {\hat{ℬ}}^{π} {\hat{Q}}_{θ}^{k} ) + 𝒞 ( Q ) ,$$

where d^{ϕ}(s) is a particular state distribution.

The minimization term is used to penalize high values at unseen states in the dataset ( [symbol] ) 221, and the maximization term is used to cancel the penalization at in-distribution states. The minimizing term may be expressed as ε( [symbol] _{s˜d}_{_{ϕ}}_{(s),a˜\hat{π}}_{^{k}}_{(a|s)}[Q (s, a)]), wherein s is the present state, a is the action, \hat{π}^{k} is the policy 212, Q is the Q-value, and d_{ϕ} is a distribution that assigns probabilities to states outside the dataset ( [symbol] ). The maximizing term may be expressed as

$$ε ( {𝔼}_{s ∼ {d}^{{π}_{β}} ( s ) , a ∼ {\hat{π}}^{k} ( a \vert s )} [ Q ( s , a ) ] )$$

wherein s is the present state, a is the action, \hat{π}^{k} is the policy 212, Q is the Q-value, and d^{π}^{_{β}} a is the marginal distribution of states in the dataset ( [symbol] ).

The regularized Q-function may then be used to push the agent towards regions close to the states from the dataset ( [symbol] ) 221, where the values are higher. To achieve the, as previously explained, the offline learning module 208 causes the processor(s) 202 to find a distribution d^{ϕ}(s) assigns high probabilities to states far away from the dataset ( [symbol] ) 221 and low probabilities to states near the dataset ( [symbol] ) 221.

In one example, to obtain a well-defined distribution d^{ϕ}, an additional optimization problem over d^{ϕ} is added to the original optimization problem. The resulting optimization problem for the policy evaluation step is:

$${min}_{Q} {max}_{{d}^{ϕ}} [ ε ( {𝔼}_{s ∼ {d}^{ϕ} ( s ) , a ∼ {\hat{π}}^{k} ( a \vert s )} [ Q ( s , a ) ] - {𝔼}_{s ∼ {d}^{π} β ( s ) , a ∼ {\hat{π}}^{k} ( a \vert s )} [ Q ( s , a ) ] ) ++ ℛ ( {d}^{ϕ} ) ] + ε ( Q , {\hat{ℬ}}^{π} {\hat{Q}}_{θ}^{k} ) + 𝒞 ( Q ) ,$$

where [symbol] (d^{ϕ}) is a regularization term to stabilize the training. If [symbol] (d^{ϕ})=−D_{KL}(d^{ϕ}(s)∥ζ(s)), where ζ(s) is the distribution obtained from uncertainty estimations, then d^{ϕ}(s)∞ζ(s)exp (V^{\hat{π}}^{^{k}}(s)), where V^{\hat{π}}^{^{k}}(s)= [symbol] _{a˜\hat{π}}_{^{k}}(a|s)[Q(s, a)]. The resulting d^{ϕ} is intuitively reasonable because it assigns high probabilities to OOD states with high uncertainty estimations. In particular, d_{ϕ} assigns higher probabilities to states with high values because it is expected to penalize harder than those with low values already.

With this choice of d_{ϕ}, the following policy evaluation step is obtained:

$${min}_{Q} J ( Q ) = {min}_{Q} ε ( log {\sum }_{s} ζ ( s ) exp ( {V}^{{\hat{π}}^{k}} ( s ) ) - {𝔼}_{s ∼ {d}^{{π}_{β}} ( s )} [ {V}^{{\hat{π}}^{k}} ( s ) ] ) + ε ( Q , {\hat{ℬ}}^{π} {\hat{Q}}_{θ}^{k} ) + 𝒞 ( Q ) .$$

The above equation is similar to weighted softmax values over the state space. It penalizes the softmax value over the state space but also considers the distances between sample points and the training data. The two terms following the trade-off factor ε is trying to decrease the discrepancy between the softmax value over OOD states and the average value over in-distribution states. The equation enforces the learned value function to output higher values at in-distribution states and lower values at OOD states. The log sumexp of the above equation mitigates the requirement for an accurate uncertainty estimation ζ(s) over the entire state space. Only those states with high values contribute to the regularization.

Once the fitted Q-function is determined, the offline learning module 208 causes the processor(s) 202 to estimate Q-values using the fitted Q-function by estimating the overall expected reward assuming the agent is in the present state and performs a present action. Thereafter, the offline learning module 208 causes the processor(s) 202 to update the policy 212 according to the existing RL algorithm.

The policy 212, once trained, can then be implemented to control a number of different agents. In particular, the policy 212 may be utilized to control robotic agents, such as autonomous vehicles. However, it should be understood that the policy 212 trained utilizing the pessimistic offline reinforcement learning methodologies described in the specification can be utilized by various agents performing various tasks and are not limited to just robotic agents.

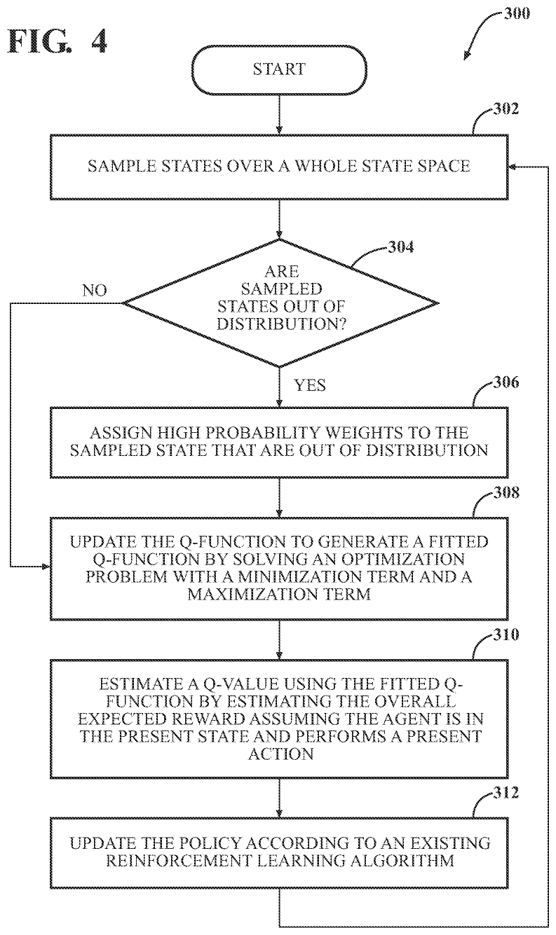

Referring to FIG. 4, an example of a method 300 for performing offline reinforcement learning to iteratively update an agent that possesses a policy and a Q-function based on a dataset ( [symbol] ) is shown. The method 300 will be described from the viewpoint of the pessimistic offline RL system 200 of FIG. 3. However, it should be understood that this is just one example of implementing the method 300. While method 300 is discussed in combination with the pessimistic offline RL system 200, it should be appreciated that the method 300 is not limited to being implemented within the pessimistic offline RL system 200 but is instead one example of a system that may implement the method 300.

It is noted that many of the steps of the method 300 were previously described when describing the pessimistic offline RL system 200. As such, any description regarding the methodologies performed by the pessimistic offline RL system 200 is equally applicable to the method 300. Furthermore, for the sake of brevity, not every detail of each step of the method 300 previously described when describing the pessimistic offline RL system 200 will be provided below, as the previous description is applicable.

In step 302, the offline learning module 208 includes instructions that, when executed by the processor(s) 202, cause the processor(s) 202 to sample states over a whole state space. The sampling of states over a whole state space can include states that are OOD and in-distribution states. As mentioned previously, in-distribution states are states that are within the dataset ( [symbol] ) 221, while OOD states are states that are not within the dataset ( [symbol] ) 221.

In step 304, the offline learning module 208 includes instructions that, when executed by the processor(s) 202, cause the processor(s) 202 to determine when sampled states are OOD. As explained previously, in one example, the offline learning module 208 causes the processor(s) 202 to train a bag of dynamics models (\hat{P}₁, \hat{P}₂, . . . , \hat{P}ₙ) according to transitions within a dataset ( [symbol] ) 221 to output an uncertainty estimation model that indicates when the present state is the OOD state. Generally, higher probabilities to OOD states, while lower probabilities are assigned to in-distribution states. For OOD states, the method 300 proceeds to step 306, wherein the offline learning module 208 includes instructions that, when executed by the processor(s) 202, causes the processor(s) 202 to assign high probability weights to the sampled states that are OOD.

In step 308, the offline learning module 208 includes instructions that, when executed by the processor(s) 202, causes the processor(s) 202 to update the Q-function to generate a fitted Q-function by solving an optimization problem with a minimization term and a maximization term. The minimization term penalizes an overall expected reward when a present state is OOD. The maximization term cancels the minimization term when the present state is in-distribution. In one example, the minimizing term is expressed as

$$ε ( {𝔼}_{s ∼ {d}_{ϕ} ( s ) , a ∼ {\hat{π}}^{k} ( a \vert s )} [ Q ( s , a ) ] ) ,$$

wherein s is the present state, a is the action, \hat{π}^{k} is the policy 212, Q is the Q-value, and d o is a distribution that assigns probabilities to states outside the dataset ( [symbol] ) 221. The maximizing term may be expressed as

$$ε ( {𝔼}_{s ∼ {d}^{{π}_{β}} ( s ) , a ∼ {\hat{π}}^{k} ( a \vert s )} [ Q ( s , a ) ] )$$

wherein s is the present state, a is the action, \hat{π}^{k} is the policy 212, Q is the Q-value, and d^{π}^{_{β}} is the marginal distribution of states in the dataset ( [symbol] ) 221.

In step 310, the offline learning module 208 includes instructions that, when executed by the processor(s) 202, causes the processor(s) 202 to estimate Q-values using the fitted Q-function by estimating the overall expected reward assuming the agent is in the present state and performs a present action. In step 312, the offline learning module 208 includes instructions that, when executed by the processor(s) 202, cause the processor(s) 202 to update the policy 212 according to an existing RL algorithm. The method 300 may be iteratively executed and may return to step 302 or stop based on whether the training is complete.

As such, the pessimistic offline RL systems and methods described in this specification can deal specifically with issues caused by OOD states by actively leading the agent back to the area where it is familiar by manipulating the value function. This is achieved by focusing on problems caused by OOD states and deliberately penalizing high values at states absent in the training dataset. The learned pessimistic value function lower bounds the true value anywhere within the state space.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein. The systems, components, and/or processes also can be embedded in a computer-readable storage, such as a computer program product or other data programs storage device, readable by a machine, tangibly embodying a program of instructions executable by the machine to perform methods and processes described herein. These elements can also be embedded in an application product, which comprises all the features enabling the implementation of the methods described herein. When loaded in a processing system, can carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Generally, module, as used herein, includes routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. As used herein, the term “plurality” is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC, or ABC).

Aspects herein can be embodied in other forms without departing from the spirit or essential attributes. Accordingly, reference should be made to the following claims, rather than to the preceding specification, as indicating the scope hereof.

What is claimed is:

1. A method for performing offline reinforcement learning to iteratively update an agent that possesses a policy and a Q-function based on a dataset ( [symbol] ), the dataset ( [symbol] ) having in-distribution states, the method comprising steps of:
sampling states over a whole state space;
determining when sampled states are out of distribution, out of distribution being a state that is not within the dataset ( [symbol] );
assigning high probability weights to the sampled states that are out of distribution;
updating the Q-function to generate a fitted Q-function by solving an optimization problem with a minimization term and a maximization term, wherein the minimization term penalizes an overall expected reward when a present state is out of distribution and the maximization term that cancels the minimization term when the present state is one of the in-distribution states;
estimating a Q-value using the fitted Q-function by estimating the overall expected reward assuming the agent is in the present state and performs a present action; and
updating the policy according to an existing reinforcement learning algorithm.

2. The method of claim 1, wherein the fitted Q-function is a conservative Q-function that lower-bounds an actual Q-function corresponding to an underlying Markov Decision Process in the dataset ( [symbol] ).

3. The method of claim 1, further comprising the step of training a bag of dynamics models (\hat{P}₁, \hat{P}₂, . . . , \hat{P}ₙ) according to transitions within a dataset (( [symbol] )) to output an uncertainty estimation model that indicates when the present state is the out of distribution state.

4. The method of claim 1, wherein:
the minimizing term is expressed as ε( [symbol] _{s˜d}_{_{ϕ}}_{(s),a˜\hat{π}}_{^{k}}_{(a|s)}[Q (s, a)]),
wherein s is the present state, a is the action, \hat{π}^{k} is the policy, Q is the Q-value, and d_{ϕ} is a distribution that assigns probabilities to states outside the dataset ( [symbol] ); and
the maximizing term is expressed as
$$ε ( {𝔼}_{s ∼ {d}^{{π}_{β}} ( s ) , a ∼ {\hat{π}}^{k} ( a \vert s )} [ Q ( s , a ) ] )$$
wherein s is the present state, a is the action, \hat{π}^{k} is the policy, Q is the Q-value, and d^{π}^{_{β}} is the marginal distribution of states in the dataset ( [symbol] ).

5. The method of claim 4, wherein the fitted Q-function further includes a regularization term [symbol] (d^{ϕ}).

6. The method of claim 5, wherein the regularization term [symbol] (d^{ϕ}) is expressed as:
−D_{KL}(d^{ϕ}(s)∥ζ(s)), where ζ(s) is the distribution obtained from uncertainty estimations, then d^{ϕ}(s)∞ζ(s)exp(V^{\hat{π}}^{^{k}}(s)), where V^{\hat{π}}^{^{k}}(s)= [symbol] _{a˜\hat{π}}_{^{k}}_{(a|s)}[Q (s, a)].

7. The method of claim 1, wherein the policy is utilized to control a robotic device.

8. A system for performing offline reinforcement learning to iteratively update an agent that possesses a policy and a Q-function based on a dataset ( [symbol] ), the dataset ( [symbol] ) having in-distribution states, the system comprising:
a processor; and
a memory in communication with the processor and storing an offline learning module having instructions that, when executed by the processor, cause the processor to:
sample states over a whole state space;
determine when sampled states are out of distribution, out of distribution being a state that is not within the dataset ( [symbol] ),
assign high probability weights to the sampled states that are out of distribution,
update the Q-function to generate a fitted Q-function by solving an optimization problem with a minimization term and a maximization term, wherein the minimization term penalizes an overall expected reward when a present state is out of distribution and the maximization term that cancels the minimization term when the present state is one of the in-distribution states,
estimate a Q-value using the fitted Q-function by estimating the overall expected reward assuming the agent is in the present state and performs a present action, and
update the policy according to an existing reinforcement learning algorithm.

9. The system of claim 8, wherein the fitted Q-function is a conservative Q-function that lower-bounds an actual Q-function corresponding to an underlying Markov Decision Process in the dataset ( [symbol] ).

10. The system of claim 8, wherein the offline learning module further includes instructions that, when executed by the processor, cause the processor to train a bag of dynamics models (\hat{P}₁, \hat{P}₂, . . . , \hat{P}ₙ) according to transitions within a dataset ( [symbol] ) to output an uncertainty estimation model that indicates when the present state is the out of distribution state.

11. The system of claim 8, wherein:
the minimizing term is expressed as ε( [symbol] _{s˜d}_{_{ϕ}}_{(s),a˜\hat{π}}_{^{k}}_{(a|s)}[Q (s, a)]),
wherein s is the present state, a is the action, \hat{π}^{k} is the policy, Q is the Q-value, and d_{ϕ} is a distribution that assigns probabilities to states outside the dataset ( [symbol] ); and
the maximizing term is expressed as ε( [symbol] _{s˜d}_{_{ϕ}}_{(s),a˜\hat{π}}_{^{k}}_{(a|s)}[Q (s, a)]) wherein s is the present state, a is the action, \hat{π}^{k} is the policy, Q is the Q-value, and d^{π}^{_{β}} is the marginal distribution of states in the dataset ( [symbol] ).

12. The system of claim 11, wherein the fitted Q-function further includes a regularization term [symbol] (d^{ϕ}).

13. The system of claim 12, wherein the regularization term [symbol] (d^{ϕ}) is expressed as:
−D_{KL}(d^{ϕ}(s)∥ζ(s)), where ζ(s) is the distribution obtained from uncertainty estimations, then d^{ϕ}(s)∞ζ(s)exp(V^{π}^{^{k}}(s)), where V^{\hat{π}}^{^{k}}(s)= [symbol] _{a˜\hat{π}}_{^{k}} (a|s) [Q(s, a)].

14. The system of claim 8, wherein the policy is utilized to control a robotic device.

15. A non-transitory computer-readable medium storing instructions for performing offline reinforcement learning to iteratively update an agent that possesses a policy and a Q-function based on a dataset ( [symbol] ), the dataset ( [symbol] ) having in-distribution states, the instructions, when executed by a processor, cause the processor to:
sample states over a whole state space;
determine when sampled states are out of distribution, out of distribution being a state that is not within the dataset ( [symbol] ),
assign high probability weights to the sampled states that are out of distribution,
update the Q-function to generate a fitted Q-function by solving an optimization problem with a minimization term and a maximization term, wherein the minimization term penalizes an overall expected reward when a present state is out of distribution and the maximization term that cancels the minimization term when the present state is one of the in-distribution states,
estimate a Q-value using the fitted Q-function by estimating the overall expected reward assuming the agent is in the present state and performs a present action, and
update the policy according to an existing reinforcement learning algorithm.

16. The non-transitory computer-readable medium of claim 15, wherein the fitted Q-function is a conservative Q-function that lower-bounds an actual Q-function corresponding to an underlying Markov Decision Process in the dataset ( [symbol] ).

17. The non-transitory computer-readable medium of claim 15, further including instructions that, when executed by the processor, cause the processor to train a bag of dynamics models (\hat{P}₁, \hat{P}₂ . . . , \hat{P}ₙ) according to transitions within a dataset ( [symbol] ) to output an uncertainty estimation model that indicates when the present state is the out of distribution state.

18. The non-transitory computer-readable medium of claim 15, wherein:
the minimizing term is expressed as ε( [symbol] _{s˜d}_{_{ϕ}}_{(s),a˜\hat{π}}_{^{k}}_{(a|s)}[Q (s, a)]), wherein s is the present state, a is the action, \hat{π}^{k} is the policy, Q is the Q-value, and d_{ϕ} is a distribution that assigns probabilities to states outside the dataset ( [symbol] ); and
the maximizing term is expressed as ε( [symbol] _{s˜d}_{_{ϕ}}_{(s),a˜\hat{π}}_{^{k}}_{(a|s)}[Q (s, a)]) wherein s is the present state, a is the action, \hat{π}^{k} is the policy, Q is the Q-value, and d^{π}^{_{β}} is the marginal distribution of states in the dataset ( [symbol] ).

19. The non-transitory computer-readable medium of claim 18, wherein the fitted Q-function further includes a regularization term [symbol] (d^{ϕ}).

20. The non-transitory computer-readable medium of claim 19, wherein the regularization term [symbol] (d^{ϕ}) is expressed as:
−D_{KL}(d^{ϕ}(s)∥(s)), where ζ(s) is the distribution obtained from uncertainty estimations, then d^{ϕ}(s)∞ζ(s)exp (V^{\hat{π}}^{^{k}}(s)), where V^{\hat{π}}^{^{k}}(s)= [symbol] _{a˜\hat{π}}_{^{k}}_{(a|s)}[Q (s, a)].
